(19) United States
(12) Patent Application Publication
(10) Pub. No.: US 2025/0264129 A1
(43) Pub. Date: Aug. 21, 2025

(54) CARABINER HOOK

(71) Applicant: ABA Hörtnagl GmbH, Fulpmes (AT)

(72) Inventor: Andreas Hörtnagl, Fulpmes (AT)

(73) Assignee: ABA Hörtnagl GmbH, Fulpmes (AT)

(21) Appl. No.: 19/056,863

(22) Filed: Feb. 19, 2025

(30) Foreign Application Priority Data
Feb. 21, 2024 (AT) A 27/2024

(51) Int. Cl. F16B 45/02

(52) U.S. Cl. CPC F16B 45/028; F16B 45/023

(57) ABSTRACT

Carabiner hook having a hook-shaped main body, a closing lever, a retaining part and an actuating lever. The main body partially surrounds a receiving opening of the carabiner hook. The closing lever is mounted on the main body via a closing lever pivot for pivoting movement between closed and maximum open positions. The closing lever is retainable in the closed position by the retaining part, and is pivotable from the closed position into the maximum open position by the actuating lever, which is mounted pivotably on the main body via an actuating lever pivot. The actuating lever exerts a pivoting action on the closing lever by an actuating pin guided in a slotted actuating hole. At least in the closed position, a distance between the actuating pin and the actuating lever pivot is at least three times greater than a distance between the actuating pin and the closing lever pivot.

### CROSS-REFERENCE TO RELATED APPLICATIONS

This application claims priority from Austrian Patent Application No. A27/2024, filed Feb. 21, 2024, which is incorporated herein by reference as if fully set forth.

### TECHNICAL FIELD

The present invention relates to a carabiner hook comprising a hook-shaped main body and a closing lever and a retaining part and an actuating lever, wherein the hook-shaped main body partially surrounds a receiving opening of the carabiner hook, and the closing lever is mounted on the hook-shaped main body by means of a closing lever pivot in such a way as to be pivotable between a closed position and a maximum open position, wherein, in the closed position, the receiving opening is closed with respect to the outside by the closing lever and, in the maximum open position, is opened to the maximum extent with respect to the outside, wherein the closing lever can be retained in the closed position by the retaining part, and the closing lever can be pivoted from the closed position into the maximum open position by means of the actuating lever, which is mounted pivotably on the hook-shaped main body by means of an actuating lever pivot, and the actuating lever exerts a pivoting action on the closing lever by means of an actuating pin guided in a slotted actuating hole.

### BACKGROUND

Carabiner hooks are known in many different configurations in the prior art. In the case of carabiner hooks which are provided primarily for use in via ferrata climbing, there is an indication in the prior art that the closing lever should be made as long as possible to avoid a situation where the fingers required to actuate the closing lever come into contact with a steel cable into which the carabiner hook is to be hooked. Such proposals are known from AT 511 633 B1, for example.

However, there are also suggestions in the prior art of equipping the carabiner hook with an actuating lever in addition to the closing lever, wherein the actuating lever pivots the closing lever when the user pivots the actuating lever with their fingers. Such carabiner hooks are known from DE 10 2010 027 153 A1, for example. Here, the closing lever and the actuating lever are situated on opposite sides of the hook-shaped main body of the carabiner hook.

Carabiner hooks of the type in question, in which there is in addition also a retaining part, are shown in FIGS. 4 and 5 of DE 10 2010 027 153 A1, wherein, in FIG. 5, the retaining part is designed as a pushbutton and, in FIG. 4, it is designed as a pivotable lever.

### SUMMARY

It is the object of the invention to develop a carabiner hook of the type in question in such a way that it is as easy as possible to operate.

For this purpose, the invention proposes a carabiner hook having one or more of the features described herein.

According to the invention, it is thus envisaged that, at least in the closed position, a distance between the actuating pin and the actuating lever pivot is at least three times, preferably at least five times, greater than a distance between the actuating pin and the closing lever pivot.

It is thus a basic concept of the invention to make the distance between the actuating pin and the actuating lever pivot significantly greater than the distance between the actuating pin and the closing lever pivot, wherein this applies at least in the closed position of the closing lever, but preferably in all the positions of the closing lever. This ensures that the actuating lever has only to be pivoted by a relatively small angle around the actuating lever pivot in order to pivot the closing lever from the closed position into the maximum open position. Carabiner hooks according to the invention can therefore be actuated relatively easily since the actuating lever has to be moved only slightly to fully pivot the closing lever.

By means of the invention, therefore, a relatively good ratio between the pivoting movement of the actuating lever around the actuating lever pivot and the pivoting movement, produced thereby, of the closing lever around the closing lever pivot is achieved.

In this context, preferred configurations of the invention also envisage that, as the actuating lever pivots through an actuating lever pivoting angle, a closing lever pivoting angle of the closing lever which is thereby brought about is at least six times, preferably at least seven times, as great as the actuating lever pivoting angle.

A very intuitive type of actuation that is familiar to users of carabiner hooks is achieved if, as envisaged in preferred configurations of the invention, the actuating lever pivot and the closing lever pivot are arranged on a first side of the hook-shaped main body, and the retaining part is secured on the hook-shaped main body on a second side of the hook-shaped main body, which is opposite the first side. This therefore enables the carabiner hook to be actuated to pivot the closing lever on the side on which the closing lever itself is also situated. It would also be possible to say that the actuating surface of the actuating lever is situated on the first side of the hook-shaped main body, on which the closing lever pivot is also situated. In this case, the actuating surface is the surface of the actuating lever on which the user presses with their fingers during actuation. As a result, the operator of the carabiner hook can actuate the closing lever mechanism on the side on which the closing lever is also situated, as is also familiar to them from simple configurations of carabiner hooks that do not have an actuating lever at all. It would also be possible to say that the actuating lever and the closing lever are arranged on the first side of the hook-shaped main body, at least in the closed position, and the retaining part is secured on the hook-shaped main body on a second side of the hook-shaped main body, which is opposite the first side.

In this context, preferred configurations of the invention envisage that the carabiner hook is elongate in one direction, and the first side and the second side lie opposite one another with respect to an imaginary longitudinal center line running in the direction of the longitudinal extent.

As is known per se from the prior art, the retaining part may also be designed as a slide or as a pushbutton in the case of carabiner hooks according to the invention. However, preferred variants of the invention envisage that the retaining part is a retaining lever mounted pivotably on the hook-shaped main body by means of a retaining part pivot. In this case, particularly preferred variants again envisage that the retaining part pivot is arranged on the second side of the hook-shaped main body. In these variants, the actuating lever pivot and the closing lever pivot are thus situated on the first side of the hook-shaped main body, and the retaining part pivot is situated on the opposite, second, side of the hook-shaped main body.

It is also advantageous if, in embodiments of the invention, it is envisaged that, in the closed position, the closing lever rests against a freely projecting end of the hook-shaped main body, and, at least in the closed position, the closing lever is arranged between the freely projecting end of the hook-shaped main body and the actuating lever. It may also be envisaged that, in the closed position, the closing lever rests against the freely projecting end of the hook-shaped main body, and the closing lever pivot is arranged between the freely projecting end of the hook-shaped main body and the actuating lever pivot. This too simplifies the intuitive operability of the carabiner hook.

In principle, the actuating pin could be arranged or formed on the closing lever, and the slotted actuating hole could be arranged or formed in the actuating lever. However, preferred variants of the invention envisage that the actuating pin is fixed on the actuating lever, and the slotted actuating hole is arranged, preferably formed, in the closing lever. In order to minimize the expenditure of force to actuate the actuating lever when pivoting the closing lever from the closed position into the maximum open position, it is advantageous if the friction between the actuating pin and the walls delimiting the slotted actuating hole is minimized. This can be achieved, for example, by minimizing a maximum displacement travel of the actuating pin in the slotted actuating hole by which the actuating pin is displaced as the closing lever is pivoted from its closed position into its maximum open position. To this end, preferred configurations of the invention envisage that the actuating pin has a diameter, measured in the slotted actuating hole, and a maximum displacement travel of the actuating pin in the slotted actuating hole is no more than twice as great as the diameter of the actuating pin, preferably less than the diameter of the actuating pin. It is thereby ensured that the actuating pin is moved over only a very small maximum displacement travel in the slotted actuating hole, and therefore also only very low frictional losses can occur.

Provision is preferably made for the retaining part to act for retention on the closing lever by means of a retaining pin. If the retaining part is a retaining lever that can be pivoted about a retaining part pivot, provision is advantageously made for the retaining pin and the retaining part pivot to be arranged spaced apart. This too applies at least in the closed position of the closing lever, but advantageously in all positions of the closing lever. Particularly stable retention of the closing lever by the retaining part is achieved if the retaining pin is supported on the hook-shaped main body when retaining the closing lever.

Preferred configurations of the invention envisage that the carabiner hook additionally has a blocking part for blocking the retaining part, wherein the retaining part blocked by the blocking part retains the closing lever in the closed position. In the case of such carabiner hooks, a blocking part is thus provided in addition to the retaining part. When the blocking part blocks the retaining part, this additionally provides yet another means of ensuring that the retaining part retains the closing lever in the closed position and cannot accidentally release the closing lever. In principle, the blocking part could also be designed as a blocking lever pivotable about a blocking part pivot. However, preferred variants of the invention envisage that the blocking part is a slidably mounted blocking slide. In this case, provision is preferably made for the blocking slide to be slidably mounted on the hook-shaped main body. As a particular preference, provision is made for the blocking part to be mounted, preferably on the hook-shaped main body, in such a way that it can be moved backward and forward between two end positions. Provision can be made for the blocking part to latch in the end positions.

In order to protect the carabiner hook against abrasion on steel cables and the like, preferred configurations of the invention envisage that the hook-shaped main body is covered, at least in some region or regions, with a polymer layer in a region adjoining the receiving opening. By means of this polymer layer, which can also be secured releasably on the hook-shaped main body, a significant noise reduction as the carabiner hook slides along steel cables and the like can also be achieved as a further effect.

### BRIEF DESCRIPTION OF THE DRAWINGS

Further features and details of preferred configurations of the invention are explained by way of example below with reference to an exemplary embodiment. In the figures:

FIG. 1 shows an exemplary embodiment of a carabiner hook according to the invention in a closed position of the closing lever, wherein the retaining part is blocked by a blocking part,

FIG. 2 shows the same carabiner hook as FIG. 1 in the closed position, wherein, however, the blocking part releases the retaining part, and

FIG. 3 shows the same carabiner hook as in FIG. 1 but in the maximum open position of the closing lever;

FIG. 4 shows a longitudinal section of FIG. 1;

FIG. 5 shows a longitudinal section of FIG. 2;

FIG. 6 shows a longitudinal section of FIG. 3;

FIG. 7 shows an enlarged partial area of FIG. 4;

FIG. 8 shows a diagrammatic drawing illustrating the relationship between the actuating lever pivoting angle and the closing lever pivoting angle on this carabiner hook; and

FIG. 9 shows an enlarged partial area of FIG. 6.

### DETAILED DESCRIPTION

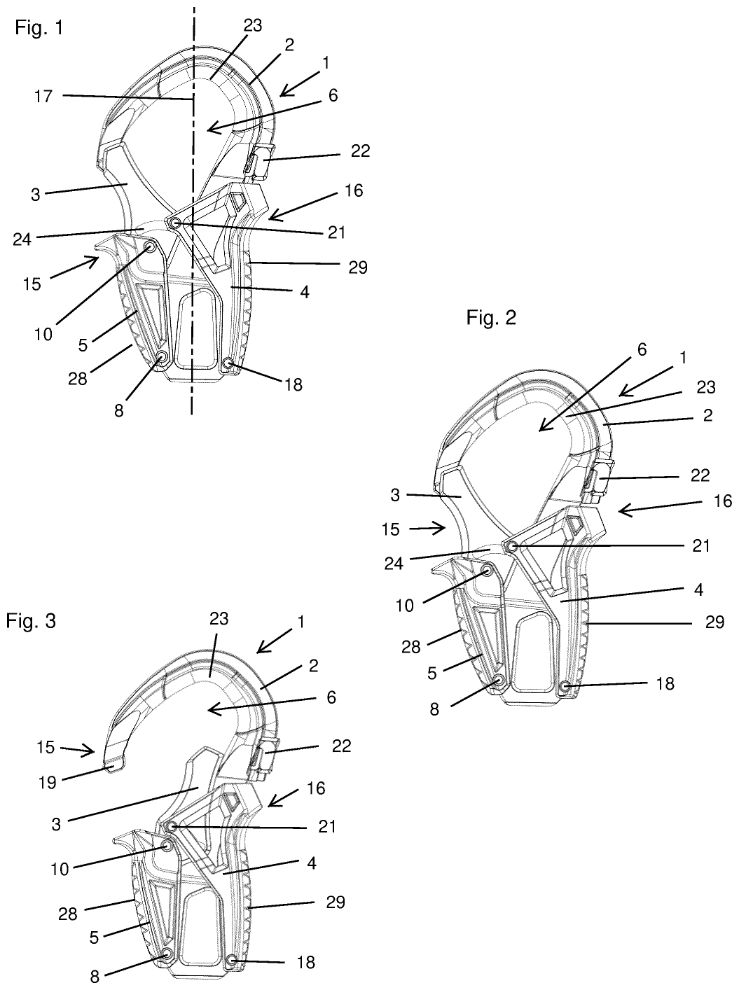

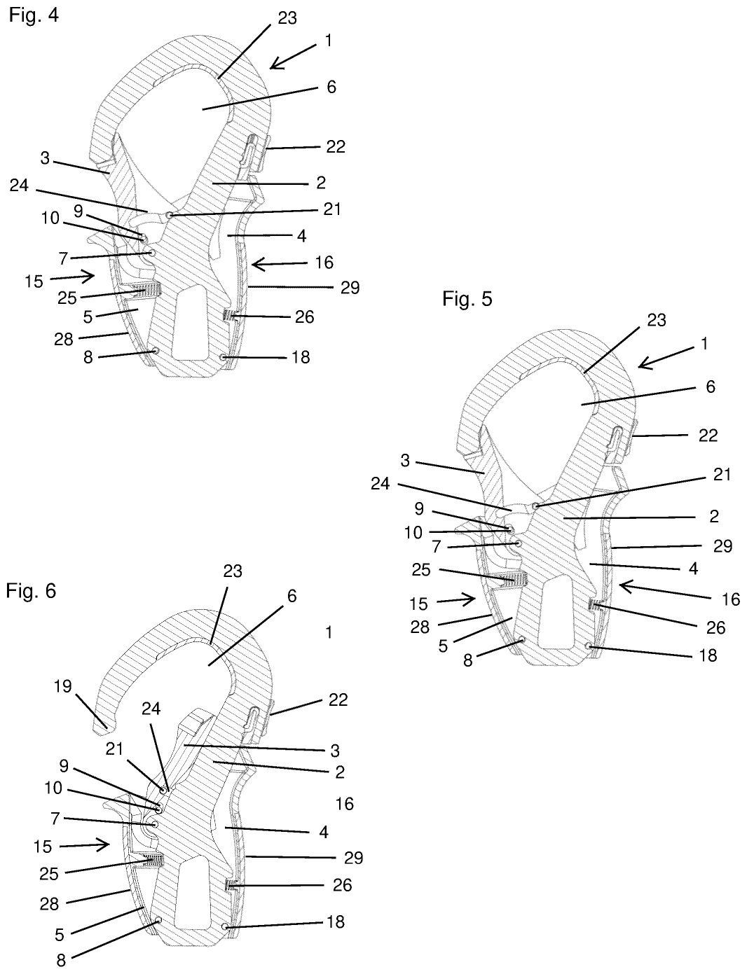

All the FIGS. 1 to 9 show illustrations relating to one and the same exemplary embodiment of a carabiner hook 1 according to the invention. FIGS. 1 to 3 shows side views, FIGS. 4 to 6 show sectioned illustrations, wherein FIG. 4 is associated with FIG. 1. FIG. 5 shows the section in the position corresponding to FIG. 2, and FIG. 6 shows the section corresponding to FIG. 3.

The carabiner hook 1 of this exemplary embodiment has a hook-shaped main body 2, a closing lever 3, a retaining part 4 and an actuating lever 5. In this exemplary embodiment, the retaining part 4 is embodied as a retaining lever. The hook-shaped main body 2 surrounds the receiving opening 6 of the carabiner hook 1 in some region or regions or in part. When the carabiner hook 1 is hooked into a rope, a bolt or the like, the rope or bolt is situated in the receiving opening 6, as is known per se. The closing lever 3 is mounted on the hook-shaped main body 2 in such a way as to be pivotable by means of its closing lever pivot 7 between a closed position illustrated in FIGS. 1, 2, 4 and 5 and the maximum open position illustrated in FIGS. 3 and 6. In its closed position, the closing lever 3 closes the receiving opening 6 with respect to the outside. In the maximally open position, the receiving opening 6 is opened as far as possible with respect to the outside, thus enabling the carabiner hook 1 to be hooked into a rope (not illustrated) or a bolt or the like. The closing lever 3 can be retained in the closed position by the retaining part 4, in this case therefore the retaining lever. This means that, when the retaining part 4 holds the closing lever 3 firmly in the closed position, the closing lever 3 cannot be pivoted out of the closed position.

Whereas, in the case of most carabiner hooks that are commercially available, the usual procedure is to press directly on the closing lever in order to pivot the closing lever from a closed position into the maximum open position, it is envisaged here, in the case of this exemplary embodiment according to the invention, that the closing lever 3 is pivoted from its closed position into the maximum open position by way of an actuating lever 5. The actuating lever 5 is mounted pivotably on the hook-shaped main body 2 by means of the actuating lever pivot 8. Transmission of movement from the actuating lever 5 to the closing lever 3 is accomplished by means of an actuating pin 10 guided in a slotted actuating hole 9.

In this exemplary embodiment, it is envisaged that the actuating pin 10 is fixed on the actuating lever 5, and the slotted actuating hole 9 is formed in the closing lever 3. This can be seen particularly clearly in the sectioned illustrations in FIGS. 4 to 6.

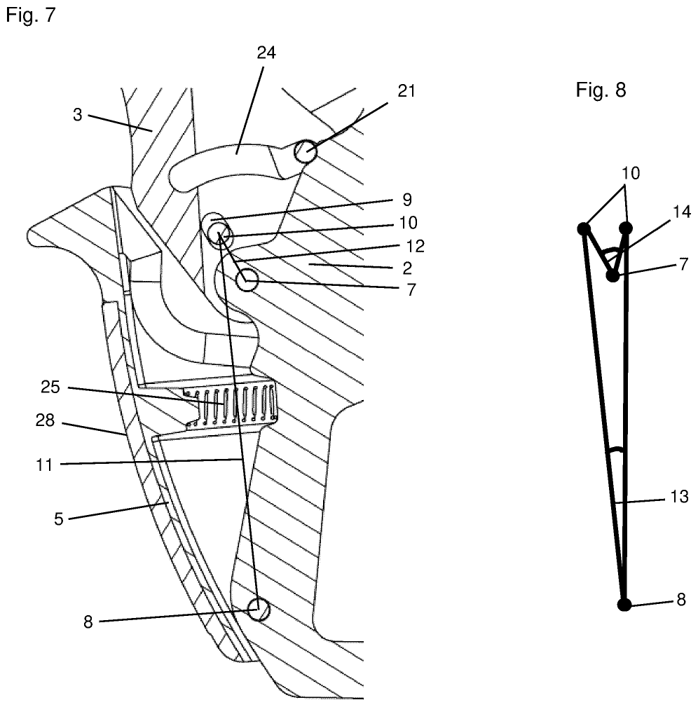

It is readily apparent in FIGS. 4 to 6 and especially in FIG. 7 that the distance 11 between the actuating pin 10 and the actuating lever pivot 8 is significantly greater than the distance 12 between the actuating pin 10 and the closing lever pivot 7. This applies in the first instance in the closed position, see FIGS. 4, 5 and 7. In preferred configurations, however, this applies in all the positions of the closing lever and, in particular, also in the maximum open position shown in FIG. 6.

FIG. 7 shows a detail of FIG. 4 on an enlarged scale. Here, the distances 11 between the actuating pin 10 and the actuating lever pivot 8 and the distance 12 between the actuating pin 10 and the closing lever pivot 7 are depicted. According to the invention, it is envisaged in this exemplary embodiment too that, at least in the closed position, the distance 11 between the actuating pin 10 and the actuating lever pivot 8 is at least three times, preferably at least five times, greater than the distance 12 between the actuating pin 10 and the closing lever pivot 7. In the configuration of the invention that is shown, and also in other preferred configurations, the situation is such that the stated distance 11 is more than six times the stated distance 12. As already explained at the outset, this ensures a particularly good leverage ratio when pivoting the closing lever 3.

To pivot the closing lever 3 from the closed position into the maximum open position, just a relatively small actuating lever pivoting angle 13 is sufficient to achieve the closing lever pivoting angle 14 required for complete opening of the closing lever 3. For this exemplary embodiment of a carabiner hook 1 according to the invention, FIG. 8 shows only the closing lever pivot 7 and the actuating lever pivot 8 as well as the actuating pin 10 in the two end positions thereof. The actuating pin 10 adopts the end position, illustrated on the left in FIG. 8, in the closed position of the closing lever 3. The position of the actuating pin 10 illustrated on the right-hand side corresponds to its position relative to the closing lever pivot 7 and to the actuating lever pivot 8 in the maximum open position of the closing lever 3. In corresponding fashion, FIG. 8 also depicts the actuating lever pivoting angle 13 and the corresponding closing lever pivoting angle 14. As already explained at the outset, it is advantageously envisaged, and also implemented in this example, that, as the actuating lever 5 pivots through the actuating lever pivoting angle 13, a closing lever pivoting angle 14 of the closing lever 3 which is thereby brought about is at least six times, preferably at least seven times, as great as the actuating lever pivoting angle 13.

In preferred configurations, such as that implemented here, it is envisaged that the actuating lever pivot 8 and the closing lever pivot 7 are arranged on a first side 15 of the hook-shaped main body 2. In preferred configurations, the retaining part 4, in contrast, is secured on the hook-shaped main body 2 on a second side 16 of the hook-shaped main body 2, which is opposite the first side 15. This can be seen clearly in FIGS. 1 to 6. The longitudinal center line 17 of this carabiner hook 1, which is elongate in a corresponding direction, is also illustrated in FIG. 1. It is clearly apparent that the first side 15 and the second side 16 lie opposite one another with respect to the imaginary longitudinal center line 17 running in the direction of the longitudinal extent of the carabiner hook 1. In preferred configurations, such as that shown here, it is then also advantageously the case that the actuating surface 28 of the actuating lever 5, on which the user of the carabiner hook 1 presses in order to pivot the actuating lever 5, is situated on the first side 15 of the carabiner hook 1. However, the actuating surface 29 of the retaining part 4 or retaining lever, on which it is necessary to press in order to pivot the retaining lever, is advantageously situated on the opposite, second, side 16, as also implemented here. In this exemplary embodiment, the retaining part pivot 18, about which the retaining part 4, in this case the retaining lever, can be pivoted, is accordingly also situated on the second side 16 of the hook-shaped main body 2.

It is also clearly evident in FIGS. 1 to 6 that, in the closed position, the closing lever 3 rests against a freely projecting end 19 of the hook-shaped main body 2. The closing lever 3 is thus situated between the freely projecting end 19 and the actuating lever 5. In this exemplary embodiment too, it is furthermore envisaged that the closing lever pivot 7 is arranged between the freely projecting end 19 of the hook-shaped main body 2 and the actuating lever pivot 8.

While the pivoting both of the actuating lever 5 and the retaining part 4 or, in this case, the retaining lever is accomplished by pressing on the corresponding actuating surfaces 28 and 29, respective return springs 25 and 26 supported on the hook-shaped main body 2 are provided for the return of these levers 4 and 5. When the user releases the actuating surface 28 of the actuating lever 5, the first return spring 25 pushes the actuating lever 5 back into its initial position as per FIGS. 1, 2, 4 and 5. By means of the coupling via the slotted actuating hole 9 and the actuating pin 10, this return of the actuating lever 5 also ensures that the closing lever 3 is pivoted back automatically from the maximum open position shown in FIGS. 3 and 6 into the closed position shown in FIGS. 1, 2, 4 and 5 by means of the first return spring 25 when the actuating surface 28 of the actuating lever 5 is correspondingly released. The second return spring 26 ensures a corresponding return of the retaining part 4, embodied as a retaining lever, when the actuating surface 29 is correspondingly released.

The actuating lever 5 can be actuated in order to pivot the closing lever 3 into its maximum open position only when the retaining part 4, here in the form of the retaining lever, releases the closing lever 3. For the coupling between the retaining part 4 and the closing lever 3, it is envisaged in preferred configurations such as the one shown here that the retaining part 4 exerts a retaining action on the closing lever 3 by means of a retaining pin 21. In this exemplary embodiment and in other preferred exemplary embodiments, the retaining pin 21 is for this purpose slidably mounted in a slotted retaining hole 24. In the variant shown here, the retaining pin 21 is fixed on the retaining part 4, i.e. on the retaining lever, while the slotted retaining hole 24 is in the closing lever 3. This is not absolutely essential: a reverse arrangement would also be conceivable. It would even be possible to implement variant embodiments in which the slotted retaining hole 24 or the retaining pin 21 were formed on the actuating lever 5 or fixed thereon.

In the exemplary embodiment shown here, it is apparent, especially in FIGS. 4, 5 and 7, that the slotted retaining hole 24 has a curved portion and an end portion angled relative to the latter. When the retaining pin 21 is situated in the angled end region of the slotted retaining hole 24, as shown in FIGS. 4, 5 and 7, the retaining part 4 retains the closing lever 3, and therefore it cannot be pivoted out of the closed position shown in FIGS. 4, 5 and 7. In this position, provision is preferably also made for the retaining pin 21 to be supported on the hook-shaped main body 2. This too can be seen clearly in FIGS. 4, 5 and 7. Only when the retaining pin 21 is transferred to the curved region of the slotted retaining hole 24 by appropriate actuation of the retaining part 4, that is to say in this case by appropriate pivoting of the retaining lever, against the preload of the second return spring 26, can the closing lever 3 be pivoted by means of the actuating lever 5 from the closed position into the maximum open position illustrated in FIG. 6.

It is readily apparent, especially in the sectioned illustrations of FIGS. 4 to 6, that this carabiner hook 1 is also equipped with a blocking part 22 in addition to the retaining part 4. This blocking part 22 serves to block the retaining part 4 as illustrated in FIGS. 1 and 4. In the position blocked by the blocking part 22, the retaining part 4 retains the closing lever 3 non-releasably in its closed position. Only when the blocking part 22 is displaced into the position shown in FIGS. 2 and 3 as well as 5 and 6, in which it no longer blocks the retaining lever 4, can the closing lever 3 be released by appropriate actuation of the retaining part 4 and then pivoted into the maximum open position. Even if this is not absolutely essential, the blocking part 22 is designed as a blocking slide here in this exemplary embodiment. This is slidably mounted on the hook-shaped main body 2. The blocking part 22, that is to say in this case the blocking slide, can be moved backward and forward on the hook-shaped main body 2, in this exemplary embodiment between two end positions. One end position is shown in FIGS. 1 and 4, and the other end position is shown in FIGS. 2, 3 as well as 5 and 6. Provision is preferably made, as also implemented here, for the blocking part 22 to latch in the end positions. For this purpose, the blocking part 22 in the exemplary embodiment shown here has a latching nose, which can latch into the corresponding recesses in the hook-shaped main body 2. However, it is of course also possible for corresponding latching functions to be implemented in some other manner known per se.

It can also be seen, particularly in the sectioned illustrations of FIGS. 4 to 6, that the hook-shaped main body 2 in this exemplary embodiment is covered, at least in some region or regions, with a polymer layer 23 in a region adjoining the receiving opening 6. By means of this polymer layer 23, it is possible to reduce abrasion on the hook-shaped main body 2 when the carabiner hook 1 is hooked into a steel cable or the like. Moreover, the polymer layer 23 also ensures a corresponding noise reduction when the carabiner hook 1 is hooked into a steel cable and is moved along the latter. The polymer layer 23 can be secured replaceably on the hook-shaped main body 2, making it easy to replace when worn.

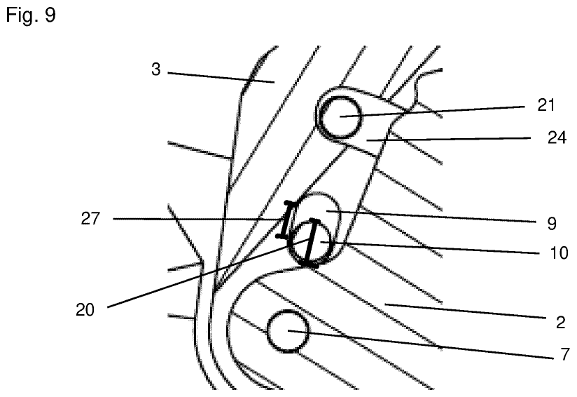

FIG. 9 then shows the region around the actuating pin 10 in the slotted actuating hole 9, on a larger scale than in FIG. 6. It is clearly apparent that, in this exemplary embodiment, the maximum displacement travel 27 of the actuating pin 10 in the slotted actuating hole 9 is in fact smaller than the diameter 20 of the actuating pin 10 in the slotted actuating hole 9. When the pivoted lever 3 is pivoted from the closed position into the maximum open position, the actuating pin 10 is thus moved by only a very small amount along the slotted actuating hole 9 in preferred exemplary embodiments such as the one shown here. There is therefore also relatively little friction. This contributes to the fact that the closing lever 3 can be actuated by means of the actuating lever 5 with relatively little expenditure of force.

### KEY TO THE REFERENCE SIGNS

1 carabiner hook
2 hook-shaped main body
3 closing lever
4 retaining part
5 actuating lever
6 receiving opening
7 closing lever pivot
8 actuating lever pivot
9 slotted actuating hole
10 actuating pin
11 distance
12 distance
13 actuating lever pivoting angle
14 closing lever pivoting angle
15 first side
16 second side
17 longitudinal center line
18 retaining part pivot
19 freely projecting end
20 diameter
21 retaining pin
22 blocking part
23 polymer layer
24 slotted retaining hole
25 first return spring
26 second return spring
27 displacement travel
28 actuating surface
29 actuating surface

1. A carabiner hook, comprising:
a hook-shaped main body;
a closing lever;
a retaining part; and
an actuating lever;
wherein the hook-shaped main body partially surrounds a receiving opening of the carabiner hook;
the closing lever is mounted on the hook-shaped main body by a closing lever pivot so as to be pivotable between a closed position and a maximum open position, wherein, in the closed position, the receiving opening is closed with respect to an outside by the closing lever and, in the maximum open position, the receiving opening is opened to the maximum extent with respect to the outside;
the closing lever is retainable in the closed position by the retaining part, and the closing lever is pivotable from the closed position into the maximum open position by the actuating lever, which is mounted pivotably on the hook-shaped main body by an actuating lever pivot; and
the actuating lever exerts a pivoting action on the closing lever via an actuating pin guided in a slotted actuating hole, wherein, at least in the closed position, a distance between the actuating pin and the actuating lever pivot is at least three times greater than a distance between the actuating pin and the closing lever pivot.

2. The carabiner hook as claimed in claim 1, wherein, as the actuating lever pivots through an actuating lever pivoting angle, a closing lever pivoting angle of the closing lever which is thereby brought about is at least six times as great as the actuating lever pivoting angle.

3. The carabiner hook as claimed in claim 1, wherein the actuating lever pivot and the closing lever pivot are arranged on a first side of the hook-shaped main body, and the retaining part is secured on the hook-shaped main body on a second side of the hook-shaped main body, which is opposite the first side.

4. The carabiner hook as claimed in claim 3, wherein the carabiner hook is elongate in one direction, and the first side and the second side lie opposite one another with respect to a longitudinal center line extending in a direction of longitudinal extent.

5. The carabiner hook as claimed in claim 1, wherein the retaining part is a retaining lever mounted pivotably on the hook-shaped main body by a retaining part pivot.

6. The carabiner hook as claimed in claim 5, wherein the actuating lever pivot and the closing lever pivot are arranged on a first side of the hook-shaped main body, the retaining part is secured on the hook-shaped main body on a second side of the hook-shaped main body, which is opposite the first side, and the retaining part pivot is arranged on the second side of the hook-shaped main body.

7. The carabiner hook as claimed in claim 1, wherein, in the closed position, the closing lever rests against a freely projecting end of the hook-shaped main body, and the closing lever pivot is arranged between the freely projecting end of the hook-shaped main body and the actuating lever pivot.

8. The carabiner hook as claimed in claim 1, wherein the actuating pin is fixed on the actuating lever, and the slotted actuating hole is arranged in the closing lever.

9. The carabiner hook as claimed in claim 1, wherein the actuating pin has a diameter, measured in the slotted actuating hole, and a maximum displacement travel of the actuating pin in the slotted actuating hole is no more than twice as great as the diameter of the actuating pin.

10. The carabiner hook as claimed in claim 1, wherein the retaining part exerts a retaining action on the closing lever via a retaining pin.

11. The carabiner hook as claimed in claim 10, wherein the retaining pin is adapted to be supported on the hook-shaped main body when retaining the closing lever.

12. The carabiner hook as claimed in claim 1, further comprising a blocking part for blocking the retaining part, and the retaining part blocked by the blocking part retains the closing lever in the closed position.

13. The carabiner hook as claimed in claim 12, wherein the blocking part is a blocking slide, which is slidably mounted.

14. The carabiner hook as claimed in claim 13, wherein the blocking slide is slidably mounted on the hook-shaped main body.

15. The carabiner hook as claimed in claim 13, wherein the blocking part is mounted such that the blocking part is movable backward and forward between two end positions.

16. The carabiner hook as claimed in claim 15, wherein the blocking part latches in the end positions.

17. The carabiner hook as claimed in claim 1, wherein the hook-shaped main body is covered, at least in some region or regions, with a polymer layer in a region adjoining the receiving opening.
